(19) United States
(12) Patent Application Publication
(10) Pub. No.: US 2020/0232162 A1
(43) Pub. Date: Jul. 23, 2020

(54) Treatment process for textile-based materials

(71) Applicant: Infinited Fiber Company Oy, Espoo (FI)

(72) Inventors: Ali Harlin, VTT (FI); Marjo Määttänen, VTT (FI); Eino Sivonen, Tampere (FI); Marianna Vehviläinen, VTT (FI); Sari Asikainen, VTT (FI); Kyösti Valta, Tampere (FI); Airi Särkilahti, VTT (FI)

(21) Appl. No.: 16/608,211

(22) PCT Filed: Apr. 27, 2018
(86) PCT No.: PCT/FI2018/050310

§ 371 Date: Oct. 25, 2019

(30) Foreign Application Priority Data
Apr. 27, 2017 (FI) 20175376

(51) Int. Cl. D21C 5/00; C08B 16/00; C08B 15/06; D01F 2/24

(52) U.S. Cl. CPC D21C 5/00; D21C 5/005; D01F 2/24; C08B 15/06; C08B 16/00

(57) ABSTRACT

The present invention relates to a process for treating textile-based materials, typically textile-based waste-materials, to prepare them for further use. The treatment includes two or more chemical and/or enzymatic treatment steps, including at least one alkaline treatment step, all intended to cause at least a partial dissolution of the textile-based material. Particularly, the process is used for the treatment of cotton-based waste materials.

### BACKGROUND OF THE INVENTION

### Field of the Invention

The present invention concerns a process for treating cellulose-based materials, typically textile-based waste-materials, to prepare them for further use. The treatment includes a chemical treatment to cause at least a partial dissolution.

Particularly, the process is used for the treatment of cotton-based waste materials.

### Description of Related Art

Currently almost all postconsumer textile waste is sent to incineration or landfills despite that even 95% of textiles are recyclable. Only some of preconsumer waste is mechanically recycled. However, since the beginning of 2016 landfilling of the used textiles has been prohibited in the EU. Thereby textiles and their raw materials that cannot be reutilized as such should be burnt in energy production.

Naturally, recycling would be preferred. Processing textile materials to obtain reusable fibres is known, e.g. from WO2013/124265A1, which describes the regeneration of a cellulose containing material by dispersing and precipitation.

Another known technique utilized in recycling is the hydrolysis of the fibres. Typically, it is preceded by a mechanical removal of metals and hard polymer pieces, such as buttons and zippers. For example, WO2010/124944A1 discloses a process for the hydrolysis of cellulose.

The Lyocell, e.g. Ioncell-F is a similar regeneration process including a dissolution of the starting material using an ionic liquid as solvent (WO2014/162062A1). The BioCelSol process, in turn, utilizes an enzymatic treatment of the starting material. Both of these processes, however, focus on preparing textiles from wood.

The regenerated fibres can subsequently be used for various purposes, including spinning or carbamation.

It is known from U.S. Pat. No. 7,662,953 how carbamate cellulose is manufactured from high quality cellulose solutions. A multi-phase dissolution technique for carbamate cellulose is introduced in U.S. Pat. No. 8,066,903, where it is taught how a low temperature is applied in the dissolution and how the solution is prepared by first wetting the mass in low diluted alkali and then in highly concentrated and strongly chilled alkali.

In carbamation it is common practice to use dissolving grade pulp. Typically, the cellulosic content of the pulp is >90% and the lignin content <1%. One possible starting material for dissolving grade pulp is cotton (or linter).

The use of pure cotton or cotton blend is not very reasonable, since there are many other uses for these pure materials. Further, the cotton also causes some difficulties. Earlier, carbamation for cotton linter has been carried out in super critical carbon dioxide environment due to the difficulty in opening up the tight fibre structure of the cotton (Yin C et al.).

However, these further uses of cotton and cotton blends will become more reasonable if the existing processes are changed to allow the use of waste cotton materials.

### SUMMARY OF THE INVENTION

The invention is defined by the features of the independent claims. Some specific embodiments are defined in the dependent claims.

According to a first aspect of the present invention, there is provided a process for treating a cotton-based textile waste material to cause regeneration of the cotton material.

According to a second aspect of the present invention, there is provided a process for chemically treating a cotton-based textile waste material to cause dissolution of the cotton material.

The focus is now on regenerating especially the cotton-based textile waste, not suited for recycling otherwise, by using chemical methods. Regeneration of cotton-based textile waste includes two main steps, which are cellulose dissolution and preparation of textile fibres.

Cellulose dissolution requires different pre-treatments of the textile waste to improve and/or refine the quality and properties of the regenerated cellulose and textile fibres. The aim is to improve reactivity of cotton by means of increasing the surface area, adjust the degree of polymerization and activation of fibres and remove impurities to improve the solubility/dissolving of cellulose. Pre-treatment of the waste material is crucial for the quality of the regenerated material and thereby it is under constant research.

Uses of product of dissolution are versatile. In the case of cotton-based textile waste the aim is usually to produce carbamate cellulose, which can then be converted into cellulosic fibres. Other main application areas are different coating applications, regenerated cellulosic films, cellulosic sponges, foams, coagulated cellulosic beads and particles.

Thus, the invention provides a low-cost method for utilizing textile waste materials in processes, where wood pulp has typically been used. The process utilizes a non-wood raw-material for producing cellulosic fibres. The process also results in a smaller CO₂ footprint compared to conventional processes.

### EMBODIMENTS OF THE INVENTION

### Definitions

In the present context, the term “fibrous” describes materials containing a sufficient amount of fibres giving it a fibrous character. Cellulosic materials are a typical example of such fibrous materials.
The term “cotton-based” material, or the term “cotton blend” includes all materials containing more than 40% cotton. However, it is preferred to use materials containing at least 70% cotton. Although some sources are labelled as “pure” cotton or “100% cotton”, they typically contain up to 10% other materials. Thus, also in the present context, it is assumed that all “cotton textiles” include up to 10% other materials.

The present invention concerns a process for treating textile-based materials, typically waste-materials, to prepare them for further use. The treatment includes two or more steps of chemical treatment to cause at least a partial dissolution of the textile material.

At least one of the chemical treatment steps is carried out using alkali. Said step is typically carried out as an alkaline extraction, and results in an increased surface area, decolorization of the raw material and removal of impurities, such as silica. When carried out at an elevated temperature (hot alkaline extraction), polyester fibres (PES) can also be removed. The use of wetting agents boosts the effect.

The removal of impurities can also be carried out using a mechanical treatment step. However, the alkaline extraction has a higher versatility and is more beneficial for the overall process.

The alkali treatment is also intended to cause swelling and some disintegration or separation of fractions. Said separation of fractions can include, e.g. dye removal or separation of textile sizing agent(s). Thus, a product of this alkali treatment is a fibre slurry.

The alkali treatment can optionally be combined with one or more other chemical treatments, e.g. by using enzymes, acids and/or bleaching chemicals.

Said acid treatment adjusts the degree of polymerization (DP) of the raw material, and decreases its metal ion content.

Metal ions are not wanted, among others since they impair the colour, disturb DP adjustment in carbamation stage, impair the filterability and spinnability, block filters, decrease fibre strength, cause clogging of spinners, decrease the uniformity of the fibre titre, act as retardants during aging, and cause light-induced yellowing as well as detrimental reactions in the presence of hydrogen peroxide.

The bleaching can include oxidative and alkaline stages. Particularly enzymes are used for bleaching (e.g. amylases, xylanases), or for adjusting the degree of polymerization (DP) of the textile material, or its fibre reactivity in the dissolution stage (e.g. endoglucanases). The oxidative stages of the bleaching are typically carried out using hydrogen peroxide, peracetic acid or ozone. These agents function by adjusting the degree of polymerization of the treated material and by bleaching it.

Refining is a further option for use as chemical treatment, and results in an increased available surface area.

According to a particularly preferred embodiment, the combination of chemical treatment steps are selected from the following alternatives, in any order considered suitable:
A. Hot alkaline extraction, with wetting agent
B. Alkaline extraction and Refining
C. Alkaline extraction, Ozone treatment, and Peroxide treatment
D. Alkaline extraction, Ozone treatment, Refining, and Peroxide treatment
E. Alkaline extraction and Peroxide treatment
F. Alkaline extraction, Enzyme treatment, and Peroxide treatment

Typically, the refining, if carried out, is carried out before or after an alkaline extraction, or before or after an ozone treatment, optionally combined with one or more further treatments.

According to one preferred option, however, the alkaline extraction of alternatives B.-F. is carried out as the first chemical treatment.

In alternatives B.-F., the alkaline extraction can be d out either as a hot alkaline extraction or at room temperature.

All of said alternatives can be supplemented with an acid treatment or acid washing to cause, among others, a further decrease in the metal content of the treated material. For example, the content of calcium (Ca), ferrous (Fe(II)) ions, copper (Cu) and manganese (Mn) can be reduced by an acid treatment.

Typically, the above described chemical treatment steps are also followed by at least one drying step. Complete removal of moisture is, however, not required.

According to an embodiment of the invention, the textile waste material is subjected to one or more mechanical pre-treatment steps before the chemical treatments, among others for removing clothing essentials, such as buttons and zips or other metal or plastic accessories. Preferably, the obtained mass is subsequently coarsely grinded.

An optional combined mechanical and enzymatic treatment will cause an improved adjustment of the degree of polymerization, and provide a pre-version of BioCelSol fibres.

The “BioCelSol” material is produced by an enzymatic treatment, followed by dissolution in an alkaline solution. To obtain the BioCelSol fibres, said treatment steps are naturally followed by a precipitation.

Typically, the carbamation is carried out by using urea and hydrogen peroxide, the latter causing a decrease of the degree of polymerization (DP) of the material, and allowing a reaction to take place, while subjecting the reaction mixture to mechanical processing, e.g. by compressing, rubbing and/or stretching.

Preferably, the obtained solid carbamate is subsequently carried through a dissolution step, typically using an alkali solution, optionally containing zinc (e.g. sodium zincate). This dissolution can be carried out either in a cold zinc solution, or by adding the carbamate into the zinc solution at room temperature, and then freezing (to −40° C.) and thawing the mixture. The obtained solution can then be filtered and used, e.g. for spinning.

According to a further embodiment, the material treated in accordance with the above described, is used in fiber spinning, or in other applications for replacing viscose, such as in sausage casings.

Alternatively, the material treated in accordance with the present invention, can be used as starting material for production of viscose, N-methyl-morpholine-N-oxide (NMMO), or ionic liquids, or Biocelsol.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

While the forgoing examples are illustrative f the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1—Chemical Treatment of Cotton-Based Material

A commercial cotton blend was subjected to various chemical treatments as shown in Tablet and the viscosity, reactivity and brightness of the resulting treated material was measured (also the results being shown in Table 1). As a comparison, it can be said that the Fock reactivity of commercial viscose grade dissolving pulp is >60%, and its viscosity is 450-500 ml/g.

TABLE 1
Properties of chemically treated cotton blends.

| | Chemical | Viscosity, | Reactivity | Bright- |
|---|---|---|---|---|
| Treatment | charge, kg/t | ml/g | (Fock), % | ness, % |
| Initial | | 880 | 12.6 | n.d. |
| cotton | | | | |
| Z-P | 35 kg O₃ + 15 kg H₂O₂/t | 320 | 34.6 | 75.6 |
| Z-P- | 35 kg O₃ + 15 kg H₂O₂/t | 320 | 68.1 | 76.2 |
| refining | | | | |
| E-Z-P | 200 kg NaOH + 6 kg O₃ + | 310 | 30.4 | 82.2 |
| | 10 kg H₂O₂/t | | | |
| E-Z- | 200 kg NaOH + 6 kg O₃ + | 350 | 51.8 | 82.0 |
| refining-P | 4 kg H₂O₂/t | | | |

n.d. = not determined
Z = ozone (O₃)
P = hydrogen peroxide (H₂O₂)
E = alkaline extraction

The metal contents of various non-treated and chemically treated cotton blends were also measured (see Table 2).

TABLE 2
Management of metal content in waste textiles.

| Treatment | Al, mg/kg | Ca, mg/kg | Co, mg/kg | Cu, mg/kg | Fe, mg/kg | Mg, mg/kg | Mn, mg/kg | Si, mg/kg as SiO₂ |
|---|---|---|---|---|---|---|---|---|
| non-treated cotton | 230 | 890 | <0.5 | 12 | 42 | 54 | 0.95 | 400 |
| A | 41 | 50 | <0.5 | 9.9 | 20 | 12 | <0.3 | 220 |
| E-P-A | 32 | 53 | <0.5 | 6.0 | 21 | 13 | <0.3 | 120 |
| HCE-A | 39 | 51 | <0.5 | 5.1 | 15 | 11 | <0.3 | 66 |
| HCE-wetting | 22 | 15 | <0.5 | 5.1 | 16 | 13 | <0.3 | 80 |
| agent-A | | | | | | | | |
| Dissolving grade | | 40-100 | 0.1 | 2 | 2-8 | 220 | 0.2-1.5 | 50 |
| pulp | | | | | | | | |

A = Acid
E = Alkaline extraction
P = hydrogen peroxide (H₂O₂)
HCE = alkaline extraction performed at elevated temperature

The properties of materials treated using a hot alkaline extraction (with wetting agent) followed by an acid treatment are shown in Table 3.

TABLE 3
Staple fibre properties.

| | Pre-treatment | | | | | |
|---|---|---|---|---|---|---|
| | Post-consumer cotton, | | | | Acid treated | |
| | treated with alkaline extraction | | | | post-consumer | |
| Parameter | (with wetting agent) and acid treatment | | | | cotton (bed sheets) | |
| Spinning speed, | 10.5 | 20 | 27 | 29 | 16.5 | 29 |
| m/min | | | | | | |
| Capacity of gear | 5.8 | 11.2 | 15.1 | 17.0 | 0.3 | 0.3 |
| pump, ml/min | | | | | | |
| Number/diameter | 2000/50 | 2000/50 | 2000/50 | 2000/50 | 100/51 | 100/51 |
| (μm) of spinneret | | | | | | |
| orifices | | | | | | |
| Stretching between | 54 | 53 | 53 | 46 | 60 | 47 |
| godets, % | | | | | | |
| Spinneret draw ratio | 0.76 | 0.77 | 0.72 | 0.49 | 0.45 | 0.45 |
| Titre of fibres, dtex | 1.52 ± 0.06 | 1.50 ± 0.02 | 1.60 ± 0.05 | 2.45 ± 0.04 | 2.16 ± 0.41 | 2.15 ± 0.47 |
| Elongation of | 18.0 ± 3.2 | 16.8 ± 2.7 | 17.6 ± 2.6 | 21.8 ± 3.0 | 16 ± 1.37 | 19.5 ± 3.0 |
| fibres, % | | | | | | |
| Tenacity of fibres, | 16.4 ± 1.5 | 15.8 ± 1.6 | 13.8 ± 0.9 | 13.3 ± 0.9 | 17.4 ± 0.9 | 16.4 ± 1.1 |
| cN/tex | | | | | | |

As these results show, the alkaline treatment provides the most effective dissolution, particularly when carried out as a hot alkaline extraction (with wetting agent) followed by an acid treatment. This alkaline treatment is preferably combined with either an ozone treatment or hydrogen peroxide treatment or both.

### INDUSTRIAL APPLICABILITY

The present material can be used as raw material for a cellulose regeneration as well as in different coating applications, regenerated cellulosic films, cellulosic sponges, coagulated cellulosic beads and particles, and generally for replacement of conventional pre-treated cellulose.

In particular, the present material is useful in recycling of both pre-consumer and post-consumer textiles by enabling the regeneration of quality cellulosic fibers from waste textiles.

### CITATION LIST

### Patent Literature

U.S. Pat. No. 7,662,953
U.S. Pat. No. 8,066,903
WO2010/124944A
WO2013/124265A1
WO2014/162062A1

### Non-Patent Literature

Yin C, Li J, Xu Q, Peng Q, Liu Y, Shen X (2007) Chemical modification of cotton cellulose in supercritical carbon dioxide: synthesis and characterization of cellulose carbamate, Carbohydr Polym 67(2):147-154

1-7. (canceled)

8. A process for refining a cotton-based textile waste material, comprising:
subjecting the cotton-based textile material to two or more treatment steps selected from chemical and optionally enzymatic treatment steps to at least partially dissolve the textile material and form a chemically treated textile material, wherein at least of the one of the two or more treatment steps comprises an alkaline extraction step, and
carrying out a carbamation step on the chemically treated textile material to produce carbamate cellulose.

9. The process of claim 8, wherein the two or more treatment further comprises an acid treatment step following the alkaline extraction.

10. The process of claim 8, wherein two or more treatment steps are selected from the group consisting of alkaline extraction at room temperature, heated alkaline extraction, acid treatment, ozone treatment, peroxide treatment, and enzymatic treatment.

11. The process of claim 8, wherein the two or more treatment steps comprises an alkaline extraction step, followed by an ozone treatment, a peroxide treatment, or both ozone and peroxide treatment.

12. The process of claim 8, wherein the cotton-based textile material comprises a solids content of >40 w-% before said two or more treatment steps.

13. The process of claim 8, wherein the chemically treated textile material comprises a solids content of about 70 w-%.

14. The process of claim 8, wherein the two or more treatments are selected from a treatment protocol selected from the group consisting of:
A. heated alkaline extraction with a wetting agent;
B. alkaline extraction and refining;
C. alkaline extraction, ozone treatment, and peroxide treatment;
D. alkaline extraction, ozone treatment, refining, and peroxide treatment;
E. alkaline extraction and peroxide treatment; and
F. alkaline extraction, enzyme treatment, and peroxide treatment.
